(19) United States
(12) Patent Application Publication
(10) Pub. No.: US 2022/0114349 A1
(43) Pub. Date: Apr. 14, 2022

(54) SYSTEMS AND METHODS OF NATURAL LANGUAGE GENERATION FOR ELECTRONIC CATALOG DESCRIPTIONS

(71) Applicant: salesforce.com, inc., San Francisco, CA (US)

(72) Inventors: Michael Sollami, Cambridge, MA (US); Aashish Jain, San Francisco, CA (US)

(21) Appl. No.: 17/067,000

(22) Filed: Oct. 9, 2020

(51) Int. Cl. G06F 40/56; G06F 40/51; G06F 16/35; G06F 40/284

(52) U.S. Cl. CPC G06F 40/56; G06F 40/51; G06Q 30/0603; G06F 40/284; G06F 16/35

(57) ABSTRACT

Systems and method are provided for selecting product corpus data. Natural language processing may be used to cluster and filter the dataset for valid descriptions of the product having a predetermined sentence length and normal natural language structure. A transformer based a multi-modal conditioned natural language generator may be instantiated based on the clustered and filtered dataset. The instantiated multi-modal conditioned natural language generator may be trained. An evaluation of an output of the multi-modal conditioned natural language generator may be performed. A product description may be generated based on the trained multi-modal conditioned natural language generator, and the product description may be output for an electronic product catalog.

### BACKGROUND

In electronic commerce, merchants use product descriptions in an electronic product catalog to communicate product features to customers. These textual details help customers identify a product to purchase, relate to the product, and improve the on-line shopping experience. A well-written product description may increase conversion rates for a merchant from the customer viewing the product to the sale of the product.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIGS. 1-4 show an example method of natural language generation to generate a product description for an electronic catalog according to implementations of the disclosed subject matter.

FIGS. 5, 6A, and 6B show multi-modal conditional natural language generators to generate a product description for an electronic product catalog according to implementations of the disclosed subject matter.

FIG. 7 shows an example of a generated product description of an item according to an implementation of the disclosed subject matter.

FIGS. 8A-8B show examples of a multi-modal conditional natural language generation system assisting a user in completing a product description according to implementations of the disclosed subject matter.

FIG. 9 shows a computer system according to an implementation of the disclosed subject matter.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

Writing effective descriptions for products for an electronic product catalog is typically time-consuming, and often requires product knowledge and/or domain expertise in marketing to produce high-quality, varying, and enticing descriptions for each product. These product copy-writing tasks are typically time-intensive and expensive, and may restrict a merchant from increasing the size of an electronic catalog.

Implementations of the disclosed subject matter use both natural language processing and natural language generation to generate human-quality product descriptions. The implementations of the disclosed subject matter use different modalities of information, such as images, text, attributes (e.g., user interests, product category, prior purchases and/or product views by a user, or the like), audio, video, or the like, to generate the product description. Natural language processing may be used to process at least a portion of the different modalities of information to form multi-modal conditions, which are provided to a transformer of a natural language generator to generate the product description. That is, the inputs to the natural language generator may be conditionalized based on images, text, attributes, and the like. Tokens and positional encoding may be generated from the images text, attributes, and the like to be provided to the transformer of the natural language generator to generate a product description based on the multimodal input.

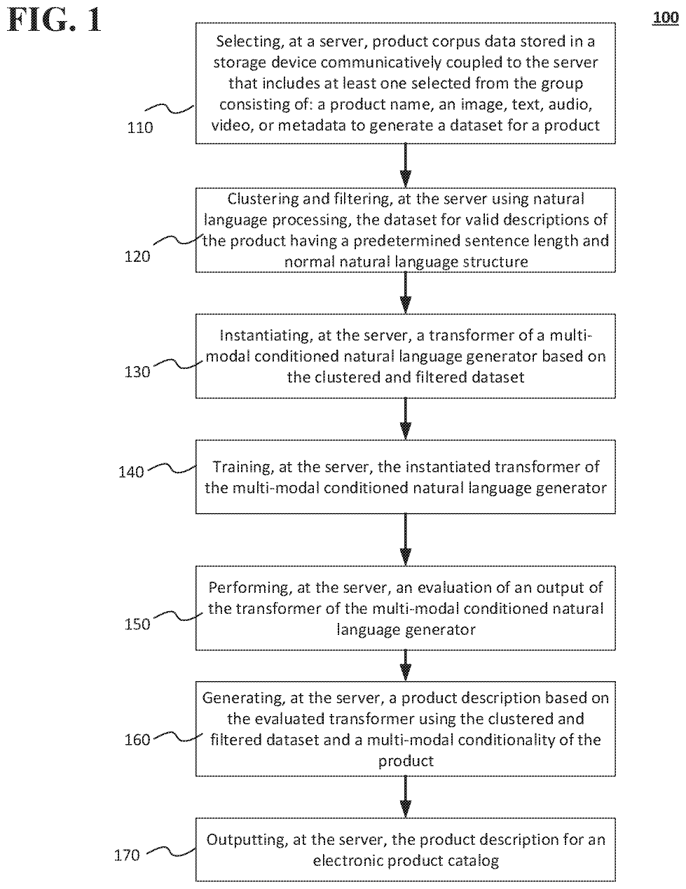

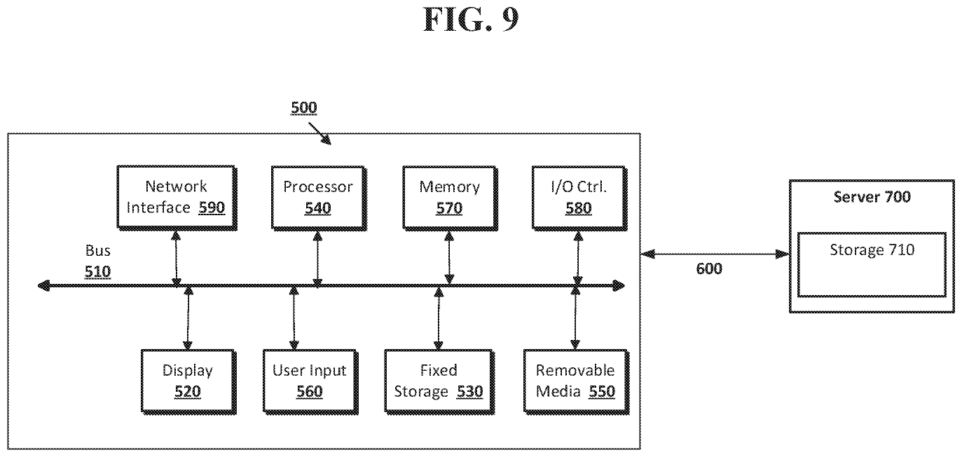

FIGS. 1-4 show an example method 100 of natural language generation to generate a product description for an electronic catalog according to implementations of the disclosed subject matter. At operation 110, a server (e.g., server 700 shown in FIG. 9) may select product corpus data stored in a storage device communicatively coupled to the server (e.g., storage 710 communicatively coupled to server 700 shown in FIG. 9). The product corpus data may include a product name, an image, text, audio, video, attributes, and/or metadata to generate a dataset for a product.

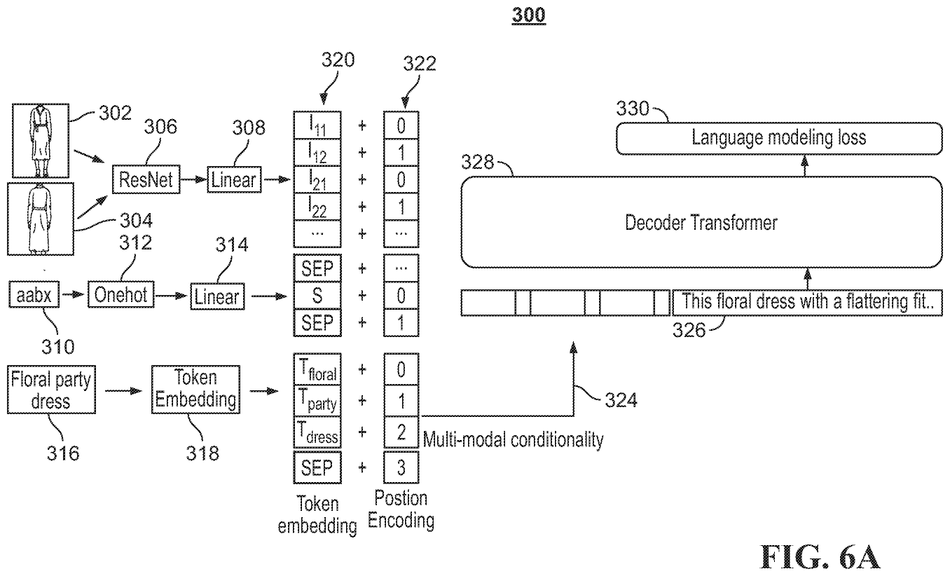

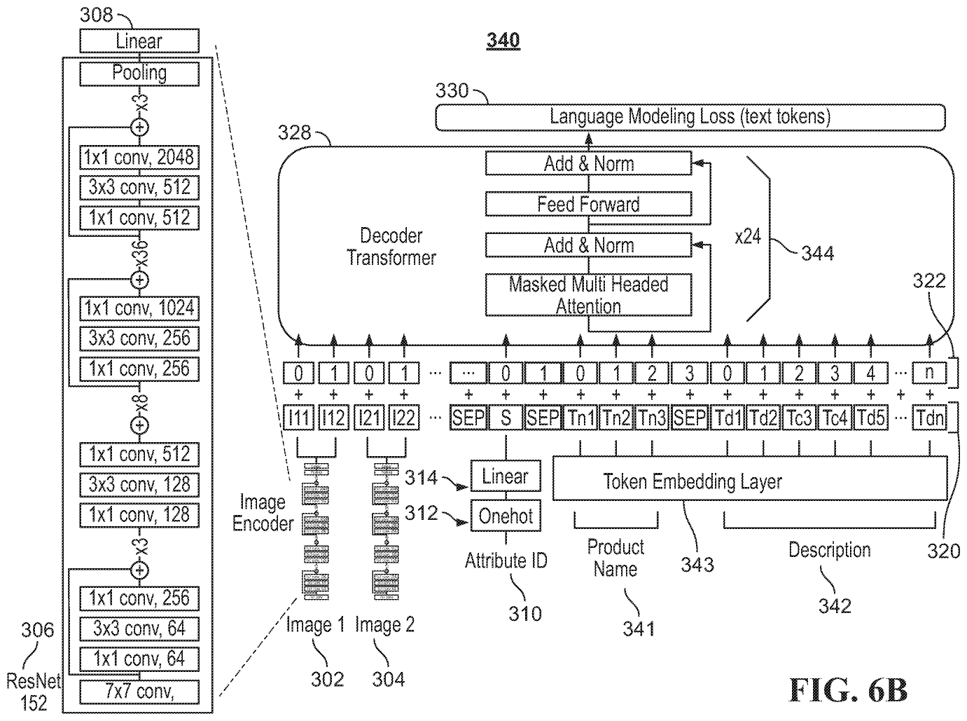

At operation 120, the server may cluster and filter, using natural language processing, the dataset for valid descriptions of the product having a predetermined sentence length and normal natural language structure. The clustering and filtering may be used to provide balance for the training a transformer (e.g., transformer 328 shown in FIGS. 6A-6B) of the natural language generator at operation 140 by having the sentences of predetermined length, such as having word length of 20 words to 120 words. That is, the sentence length may be, for example, greater than or equal to 20 words, 30 words, 50 words, 80 words, 100 words, 120 words, or the like. In some implementations, the server may filter and cluster the dataset so that the data may have a normal natural language structure, with clean descriptions in valid English. The natural language processing may include, for example, classification of words, sentiment of a word, key topics, annotation, parsing, and the like.

In some implementations, the clustering and filtering at operation 120 may include translating one or more words of the dataset from a first natural language (e.g., French, Spanish, Russian, Mandarin Chinese, Arabic, Hindi, and the like) to a predetermined natural language (e.g., English). This translation may be performed so that the words to be processed by the natural language processor are in the same language.

In some implementations, the clustering and filtering at operation 120 may include removing one or more characters of the dataset based on a predetermined list of characters. For example, the clustering and filtering may be used to remove non-ASCII (American Standard Code for Information Interchange) characters. This removal of characters may be performed so that the natural language processor is provided with words of a predetermined language, without extraneous characters.

At operation 130, the server may instantiate a transformer of a multi-modal conditioned natural language generator based on the clustered and filtered dataset. The instantiation may include training the transformer (e.g., transformer 328 shown in FIGS. 6A-6B) using one or more datasets (e.g., the clustered and filtered dataset from operation 120), where the weights of one or more parameters may be set to a predetermined value

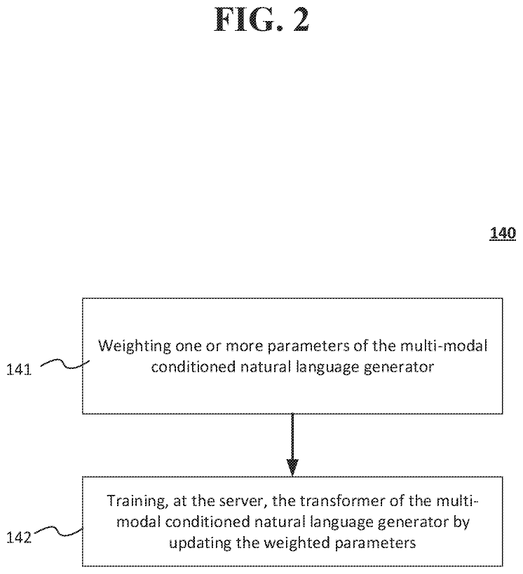

At operation 140, the server may train the instantiated transformer of the multi-modal conditioned natural language generator. FIG. 2 shows example operations of the training operation 140 according to an implementation of the disclosed subject matter. At operation 141, the server may weight one or more parameters of the multi-modal conditioned natural language generator. In some implementations, the weight of the parameters may be set to 1 or any other suitable value for training purposes. At operation 142, the server may train the transformer of the multi-modal conditioned natural language generator by updating the weighted parameters.

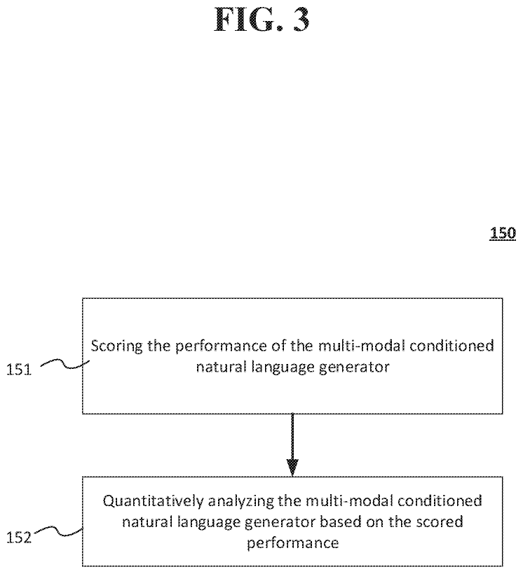

At operation 150, the server may perform an evaluation of an output (e.g., a sample product description) of the transformer of the multi-modal conditioned natural language generator. FIG. 3 shows example operations of the performing the evaluation at operation 150 according to an implementation of the disclosed subject matter. At operation 151, the server may score the performance of the multi-modal conditioned natural language generator.

For example, the server may score the performance (e.g., of the generated sample product description) using perplexity scores, BLEU scores, ROUGE scores, or the like. The perplexity scores may be used to determine how well a probability distribution or probability model predicts a product description. The perplexity score may be used to determine how well the transformer of the multi-modal conditioned natural language generator is trained, based on the sample product description output. A low perplexity score (e.g., a score that is below a predetermined scores) may indicate that the transformer of the multi-modal conditioned natural language generator is good at predicting and/or generating the product description.

In another example, a BLEU (bilingual evaluation understudy) score may be computed by the server to determine the performance of the multi-modal conditioned natural language generator. BLEU may evaluate the quality of text which has been generated by the transformer of the multi-modal conditioned natural language generator (e.g., of the generated sample product description). For example, quality may be the correspondence between a product description generated by the transformer, and a human. Scores may be calculated for a product description by comparing a reference description for the product with one generated by the trained transformer of the multi-modal conditioned natural language generator. The BLEU score may be a number between 0 and 1. This value may indicate how similar the generated product description is to the reference product description, with values closer to 1 representing more similar texts.

In another example, the server may compute a ROUGE (Recall-Oriented Understudy for Gisting Evaluation) score, which may be used to evaluate the generated product description against a reference product description.

At operation 152 of FIG. 3, the server may quantitatively analyze the multi-modal conditioned natural language generator based on the scored performance (e.g., based on the perplexity scores, the BLEU scores, the ROUGE scores, or the like). That is, based on the scores, the transformer of the natural language generator may receive additional training with a different dataset, different weighting, or the like. In some implementations, the transformer may be trained so as to reduce or increase the importance of one or more of the image data, text, attributes, audio, and/or video in generating a product description.

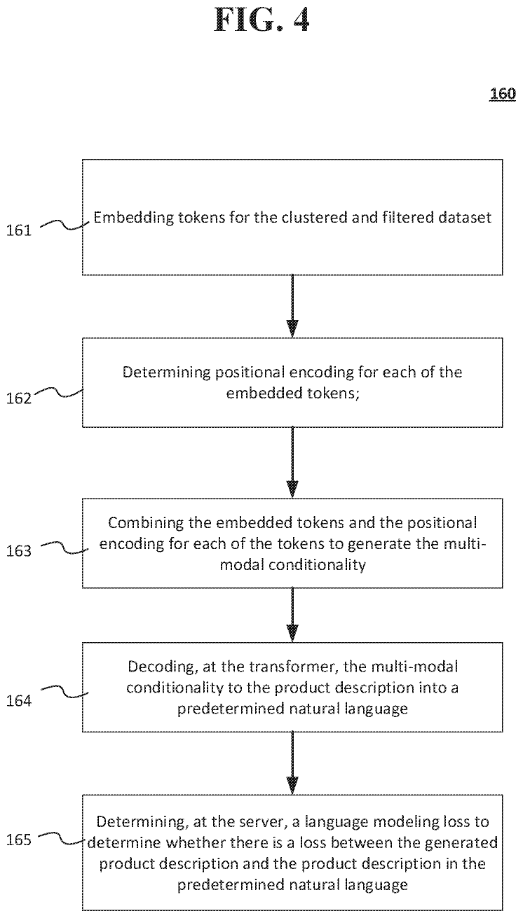

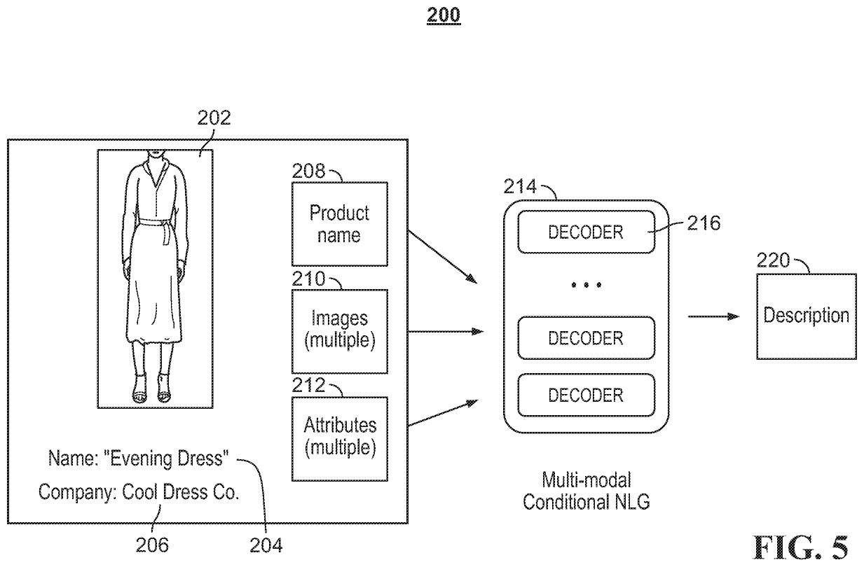

At operation 160 of FIG. 1, the server may generate a product description based on the evaluated transformer using the clustered and filtered dataset and a multi-modal conditionality based on the product. FIG. 4 shows example operations of generating the product description at operation 160 according to an implementation of the disclosed subject matter. At operation 161, the server may embed tokens for the clustered and filtered dataset. At operation 162, the server may determine positional encoding for each of the embedded tokens. The token embedding and positional encoding is described in detail below in connection with FIGS. 5, 6A, and 6B.

At operation 163, the server may combine the embedded tokens and the positional encoding for each of the tokens to generate the multi-modal conditionality. As described below in connection with FIG. 6A, the multi-modal conditionality may be generated and provided to the transformer. At operation 164, the transformer may decode the multi-modal conditionality to the product description into a predetermined natural language. For example, the predetermined natural language for the product description may be English. At operation 165, the server may determine a language modeling loss to determine whether there is a loss between the generated product description and the product description in the predetermined natural language. The determination of losses is described in detail below in connection with the language modeling loss 330 of FIGS. 6A-6B.

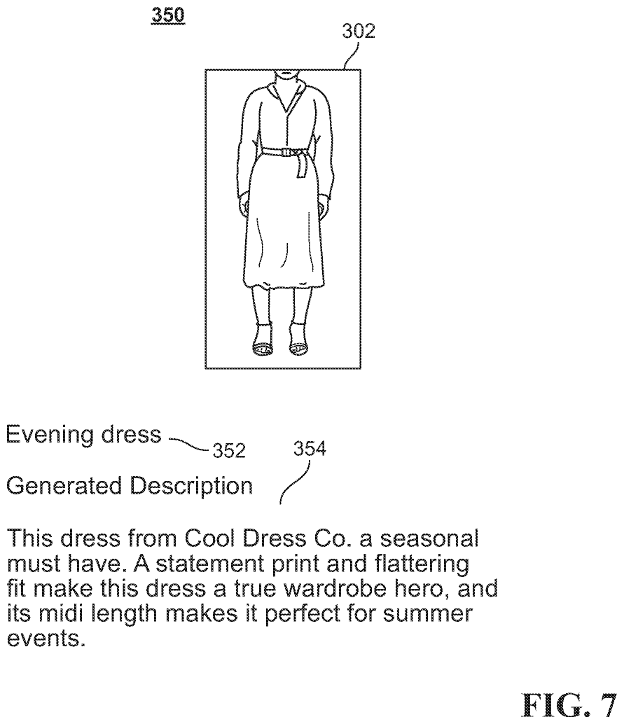

At operation 170, the server may output the product description for an electronic product catalog. FIG. 7 shows an example of a generated description of an item according to an implementation of the disclosed subject matter. Display 350 may be displayed of computer 500 shown in FIG. 9, and may include image 302, product title 352, and the generated description 354 that may be output from the decoder transformer 328, and/or the language modeling loss 330 shown in FIGS. 6A-6B.

FIGS. 5, 6A, and 6B show multi-modal conditional natural language generators to generate a product description for an electronic product catalog according to implementations of the disclosed subject matter. FIG. 5 shows multi-modal conditional natural language system 200 that may be implemented on server 700 shown in FIG. 9. A product image 202, a name 204 (e.g., “evening dress”), and a company name 206 (e.g., “Cool Dress Co.”) may be multimodal product corpus data described above. The product image 202 may be tokenized to form tokenized images 210. Tokenization may be described in detail below in connection with FIG. 6. Although only product image 202 is shown in FIG. 5, there may be a plurality of images that are tokenized to form tokenized images 210. Similarly, the name 204 may be tokenized to form tokenized product name 208, and the company name 206 may be tokenized for tokenized attributes 212. Although not shown in FIG. 5, there may be text and/or other information that may be tokenized to form the tokenized attributes 212. For example, the attributes may include the available sizes of the product, the dimensions of the product, material that the product is made of, other available colors and/or prints, or the like.

The tokenized product name 208, tokenized images 210, and the tokenized attributes 212 may be provided to a multi-modal conditional natural language generator (NLG) 214, which may be provided by the server 700 shown in FIG. 9. The different types of data (e.g., images, text, and the like) from the tokens 208, 210, 212 may server as the multi-modal conditions for which the natural language generator may use to generate a product description. One or more decoders 216 may be used by the multi-modal conditional natural language generator 214. In some implementations, each type of token (e.g., based on the modality of the information to generate the token) may be handled by a separate decoder 216. The multi-modal conditional natural language generator 214 may output a product description 220.

The system 300 shown in FIG. 6A may be a more detailed version of system 200 shown in FIG. 5, and may be implemented on server 700 shown in FIG. 9. Images 302 and/or 304 may be part of the multimodal product corpus data, and may be provided to a residual network (ResNet) 306 that may be an artificial neural network to process the images to form image tokens, and linear processor 308 may process the tokens so that they may be embedded. For example, the tokens Iii, 112 may be formed for the image 302, and the tokens 121, 122 may be formed for the image 304. In some implementations, each image may have at least two tokens associated with the image.

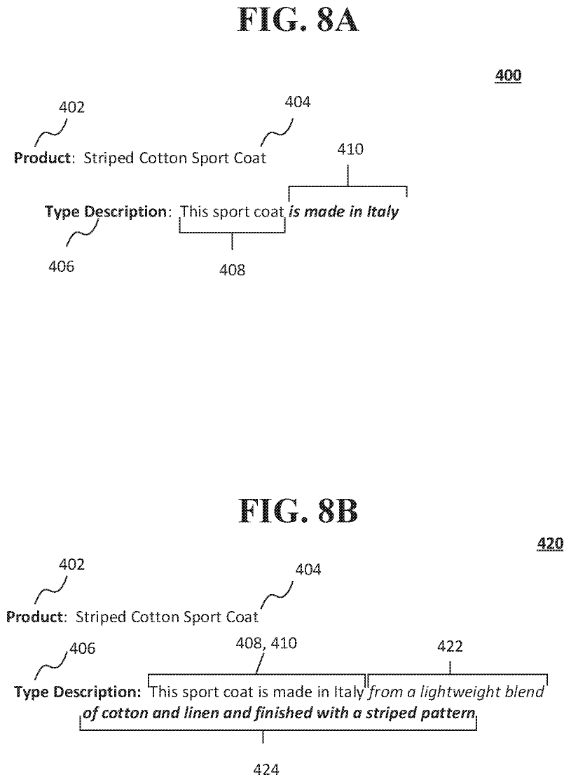

Attribute 310 (e.g., a company name) may be part of the multimodal product corpus data, and may be tokenized though one-hot processor 312 and a linear processor 314. In some implementations, attributes of the product may be tokenized by the one-hot processor 312 and a linear processor 314. The one-hot processor may be form a group of bits among which the legal combinations of values have a single high (1) bit and all the others low (0). The attribute 310 (e.g., company name) may be tokenized and embedded as a single “S” token, where “S” equates to a string (e.g., a portion of text). This token may be separated from the image tokens with a separator token (“SEP”). Text 316 (e.g., “floral party dress”) may be tokenized by token embedder 318 to form three tokens, T_{floral}, T_{party}, and T_{dress}. The text tokens may be separated from the company title (e.g., the S token) with a separator token (“SEP”). The images, attributes, text, and separators may be embedded tokens 320. Each of the embedded tokens 320 may have positional encoding 322. The positional encoding may be used to indicate the order of the tokens. The separator tokens between the image, attributes, and text tokens may have positional encoding. The embedded tokens 322 and positional encoding 322 may be concatenated to form the multi-modal conditioning 324. In some implementations, the multi-modal conditionality 324 may be combined with input text 326 that may be provided by a user (e.g., as discussed below in connection with FIGS. 8A-8B). The multi-modal conditionality 324 and/or the input text 326 may be provided to the decoder transformer 328, which may generate a product description based on the tokenized inputs. The transformer may decode the tokens to generate a product description in a predetermine language (e.g., English).

The transformer (e.g., decoder transformer 328 shown in FIG. 6A) may be trained using language modeling loss (e.g., language modeling loss 330 shown in FIGS. 6A-6B). Given previous words, cross entropy loss may be determined by the server (e.g., server 700 shown in FIG. 9) between a predicted distribution of next words and a real next word, by using the following:

$$Loss = - {\sum }_{i} log p ( {x}_{i} \vert {x}_{1} , … , {x}_{i - 1} )$$

where, xᵢ is the next token the transformer predicts given the previous tokens from 1 to i−1. In some implementations, training the loss may be determined for the text tokens (e.g., the product name, product descriptions, and the like). For image tokens and the one-hot encoded attributes (e.g., a company name), no loss may be computed as the transformer outputs the distribution over the text tokens. In some implementations, the image tokens and the attribute tokens may be considered in the previous tokens when predicting the distribution for the next word.

The system 340 shown in FIG. 6B may be a more detailed version of system 300 shown in FIG. 6A and described in detail above, and may be implemented on server 700 shown in FIG. 9. Images 302, 304 may be encoded as tokens using the residual network (ResNet) 306 and the linear processor 308. The attribute 310 may be tokenized using the one-hot processor 312 and a linear processor 314. A product name 341 and/or description 342 may be text and/or other information that may be tokenized by the token embedding layer 343. The images 302, 304, the attributes 310, the product name 341, and product description 342, along with spacer tokens may be form embedded tokens 320, with each token having positional encoding 322. The transformer 328 may include decoders 344, which may generate a product description based on the tokenized and ordered inputs. The decoders 344 may decode the tokens, and the transformer 328 may generate a product description in a predetermine language (e.g., English). Language modeling loss 330 may be used to minimize loss and/or provide considerations for training the transformer 328 as discuss above.

The product description output by the transformer 328 of FIGS. 6A-6B may be shown display 350 shown in FIG. 7 according to an implementation of the disclosed subject matter. Display 350 may include at least one of the images (e.g., image 302) that may have been tokenized by the transformer 328 of FIG. 6. The display 350 may include a product title 352 (e.g., “Evening dress”), and a generated description 354. The display 350, including the generated product description 354, may be added to an electronic product catalog of a merchant.

FIGS. 8A-8B show examples of a multi-modal conditional natural language generation system assisting a user in completing a product description according to implementations of the disclosed subject matter. In FIG. 8A, display 400 that may be output by computer 500 shown in FIG. 5 may include a product 402 having a product name 404 (e.g., “Striped Cotton Sport Coat”). The type description 406 may be a portion of the display that a user may enter a product description using user input 560 of computer 500 shown in FIG. 9. For example, the user may enter a first typed portion 408, which may be sent to the server 700 shown in FIG. 9 to generate text based on the typed portion 408 (e.g., “This sport coat”). A first description portion 410 (e.g., “is made in Italy”) may be generated by the server (e.g., using the system 300 shown in FIG. 6), and may be transmitted to computer 500 to be displayed in the display 400 of the computer 500.

FIG. 8B shows display 420, which includes the product 402 having the product name 404 from display 400 shown in FIG. 8A. The type description 406 may include the first typed portion 408, as well as the first description portion 410 generated by the server. Following the first description portion 410, the user may enter a second typed portion 422 (e.g., “from a lightweight blend”), and the server may subsequently generated second description portion 424, based on the first typed portion 408, the second typed portion 422, and the first description portion 410. The resulting combination of the first typed portion 408, the first description portion 410, the second typed portion 422 and the second description portion 424 may form a product description for the product 402.

Implementations of the presently disclosed subject matter may be implemented in and used with a variety of component and network architectures. FIG. 9 is an example computer 500 suitable for implementing implementations of the presently disclosed subject matter. As discussed in further detail herein, the computer 500 may be a single computer in a network of multiple computers. In some implementations, the computer 500 may be used to request a generation of a product description, provide text, images, and/or attributes to be used to generate a product description, and/or display a generated product description. As shown in FIG. 9, the computer 500 may communicate with a server 700 (e.g., a server, cloud server, database, cluster, application server, neural network system, or the like) via a wired and/or wireless communications network 600. The server 700 may include a storage device 710. The storage 710 may use any suitable combination of any suitable volatile and non-volatile physical storage mediums, including, for example, hard disk drives, solid state drives, optical media, flash memory, tape drives, registers, and random access memory, or the like, or any combination thereof.

The storage 710 of the server 700 can store data, such as an electronic product catalog; images, text, and/or attributes; generated tokens; the transformer and/or decoders; generated product descriptions, and the like. Further, if the server 700 and/or storage 710 is a multitenant system, the storage 710 can be organized into separate log structured merge trees for each instance of a database for a tenant. Alternatively, contents of all records on a particular server or system can be stored within a single log structured merge tree, in which case unique tenant identifiers associated with versions of records can be used to distinguish between data for each tenant as disclosed herein. More recent transactions can be stored at the highest or top level of the tree and older transactions can be stored at lower levels of the tree. Alternatively, the most recent transaction or version for each record (i.e., contents of each record) can be stored at the highest level of the tree and prior versions or prior transactions at lower levels of the tree.

The computer (e.g., user computer, enterprise computer, or the like) 500 may include a bus 510 which interconnects major components of the computer 500, such as a central processor 540, a memory 570 (typically RAM, but which can also include ROM, flash RAM, or the like), an input/output controller 580, a user display 520, such as a display or touch screen via a display adapter, a user input interface 560, which may include one or more controllers and associated user input or devices such as a keyboard, mouse, Wi-Fi/cellular radios, touchscreen, microphone/speakers and the like, and may be communicatively coupled to the I/O controller 580, fixed storage 530, such as a hard drive, flash storage, Fibre Channel network, SAN device, SCSI device, and the like, and a removable media component 550 operative to control and receive an optical disk, flash drive, and the like.

The bus 510 may enable data communication between the central processor 540 and the memory 570, which may include read-only memory (ROM) or flash memory (neither shown), and random access memory (RAM) (not shown), as previously noted. The RAM may include the main memory into which the operating system, development software, testing programs, and application programs are loaded. The ROM or flash memory can contain, among other code, the Basic Input-Output system (BIOS) which controls basic hardware operation such as the interaction with peripheral components. Applications resident with the computer 500 may be stored on and accessed via a computer readable medium, such as a hard disk drive (e.g., fixed storage 530), an optical drive, floppy disk, or other storage medium 550.

The fixed storage 530 can be integral with the computer 500 or can be separate and accessed through other interfaces. The fixed storage 530 may be part of a storage area network (SAN). A network interface 590 can provide a direct connection to a remote server via a telephone link, to the Internet via an internet service provider (ISP), or a direct connection to a remote server via a direct network link to the Internet via a POP (point of presence) or other technique. The network interface 590 can provide such connection using wireless techniques, including digital cellular telephone connection, Cellular Digital Packet Data (CDPD) connection, digital satellite data connection or the like. For example, the network interface 590 may enable the computer to communicate with other computers and/or storage devices via one or more local, wide-area, or other networks.

Many other devices or components (not shown) may be connected in a similar manner (e.g., data cache systems, application servers, communication network switches, firewall devices, authentication and/or authorization servers, computer and/or network security systems, and the like). Conversely, all the components shown in FIG. 9 need not be present to practice the present disclosure. The components can be interconnected in different ways from that shown. Code to implement the present disclosure can be stored in computer-readable storage media such as one or more of the memory 570, fixed storage 530, removable media 550, or on a remote storage location.

In some implementations, the server shown in FIG. 9 can store the data (e.g., the electronic product catalog, generated tokens, product descriptions, and the like) in the immutable storage of the at least one storage device (e.g., storage 710) using a log-structured merge tree data structure.

The systems and methods of the disclosed subject matter can be for single tenancy and/or multitenancy systems. Multitenancy systems can allow various tenants, which can be, for example, developers, users, groups of users, and/or organizations, to access their own records (e.g., tenant data and the like) on the server system through software tools or instances on the server system that can be shared among the various tenants. The contents of records for each tenant can be part of a database containing that tenant. Contents of records for multiple tenants can all be stored together within the same database, but each tenant can only be able to access contents of records which belong to, or were created by, that tenant. This may allow a database system to enable multitenancy without having to store each tenants' contents of records separately, for example, on separate servers or server systems. The database for a tenant can be, for example, a relational database, hierarchical database, or any other suitable database type. All records stored on the server system can be stored in any suitable structure, including, for example, a log structured merge (LSM) tree.

Further, a multitenant system can have various tenant instances on server systems distributed throughout a network with a computing system at each node. The live or production database instance of each tenant may have its transactions processed at one computer system. The computing system for processing the transactions of that instance may also process transactions of other instances for other tenants.

Some portions of the detailed description are presented in terms of diagrams or algorithms and symbolic representations of operations on data bits within a computer memory. These diagrams and algorithmic descriptions and representations are commonly used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, however, that all these and similar terms are to be associated with the appropriate physical quantities and are merely convenient labels applied to these quantities. Unless specifically stated otherwise as apparent from the above discussion, it is appreciated that throughout the description, discussions utilizing terms such as “selecting,” “clustering,” “instantiating,” “training,” “updating,” “performing,” “generating,” “outputting,” “translating,” “removing,” “weighting,” “scoring,” “analyzing,” “embedding,” “determining,” “combining,” “decoding,” “transmitting,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

More generally, various implementations of the presently disclosed subject matter can include or be implemented in the form of computer-implemented processes and apparatuses for practicing those processes. Implementations also can be implemented in the form of a computer program product having computer program code containing instructions implemented in non-transitory and/or tangible media, such as hard drives, solid state drives, USB (universal serial bus) drives, CD-ROMs, or any other machine readable storage medium, wherein, when the computer program code is loaded into and executed by a computer, the computer becomes an apparatus for practicing implementations of the disclosed subject matter. Implementations also can be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium can be implemented by a general-purpose processor, which can transform the general-purpose processor or a device containing the general-purpose processor into a special-purpose device configured to implement or carry out the instructions. Implementations can be implemented using hardware that can include a processor, such as a general purpose microprocessor and/or an Application Specific Integrated Circuit (ASIC) that implements all or part of the techniques according to implementations of the disclosed subject matter in hardware and/or firmware. The processor can be coupled to memory, such as RAM, ROM, flash memory, a hard disk or any other device capable of storing electronic information. The memory can store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described to explain the principles of implementations of the disclosed subject matter and their practical applications, to thereby enable others skilled in the art to utilize those implementations as well as various implementations with various modifications as can be suited to the particular use contemplated.

1. A method comprising:
selecting, at a server, product corpus data stored in a storage device communicatively coupled to the server that includes at least one selected from the group consisting of: a product name, an image, text, audio, video, or metadata to generate a dataset for a product;
clustering and filtering, at the server using natural language processing, the dataset for valid descriptions of the product having a predetermined sentence length and normal natural language structure;
instantiating, at the server, a transformer of a multi-modal conditioned natural language generator based on the clustered and filtered dataset;
training, at the server, the instantiated transformer of the multi-modal conditioned natural language generator;
performing, at the server, an evaluation of an output of the transformer of the multi-modal conditioned natural language generator;
generating, at the server, a product description based on the evaluated transformer using the clustered and filtered dataset and a multi-modal conditionality of the product; and
outputting, at the server, the product description for an electronic product catalog.

2. The method of claim 1, wherein the clustering and filtering further comprises:
translating one or more words of the dataset from a first natural language to a predetermined natural language.

3. The method of claim 1, wherein the clustering and filtering further comprises:
removing one or more characters of the dataset based on a predetermined list of characters.

4. The method of claim 1, wherein the training further comprises:
weighting one or more parameters of the multi-modal conditioned natural language generator; and
training, at the server, the transformer of the multi-modal conditioned natural language generator by updating the weighted parameters.

5. The method of claim 1, wherein the performing the evaluation further comprises:
scoring the performance of the multi-modal conditioned natural language generator;
quantitatively analyzing the multi-modal conditioned natural language generator based on the scored performance.

6. The method of claim 1, wherein the generating the product description further comprises:
embedding tokens for the clustered and filtered dataset;
determining positional encoding for each of the embedded tokens; and
combining the embedded tokens and the positional encoding for each of the tokens to generate the multi-modal conditionality.

7. The method of claim 6, further comprising:
decoding, at the transformer, the multi-modal conditionality to the product description into a predetermined natural language.

8. The method of claim 7, further comprising:
determining, at the server, a language modeling loss to determine whether there is a loss between the generated product description and the product description in the predetermined natural language.

9. The method of claim 1, further comprising:
transmitting, at the server, one or more natural language words for the product description to a user interface based on at least one input received by the user interface.

10. A system comprising:
a server having a processor and memory to:
select product corpus data stored in the memory that includes at least one selected from the group consisting of: a product name, an image, text, audio, video, or metadata to generate a dataset for a product;
cluster and filter, using natural language processing, the dataset for valid descriptions of the product having a predetermined sentence length and normal natural language structure;
instantiate a transformer of a multi-modal conditioned natural language generator based on the clustered and filtered dataset;
train the instantiated transformer of the multi-modal conditioned natural language generator;
perform an evaluation of an output of the transformer of the multi-modal conditioned natural language generator;
generate a product description based on the evaluated transformer using the clustered and filtered dataset and a multi-modal conditionality of the product; and
output the product description for an electronic product catalog.

11. The system of claim 10, wherein the server clusters and filters by translating one or more words of the dataset from a first natural language to a predetermined natural language.

12. The system of claim 10, wherein the server clusters and filters by removing one or more characters of the dataset based on a predetermined list of characters.

13. The system of claim 10, wherein the server trains by weighting one or more parameters of the multi-modal conditioned natural language generator, and training the transformer of the multi-modal conditioned natural language generator by updating the weighted parameters.

14. The system of claim 10, wherein the server performs the evaluation by scoring the performance of the multi-modal conditioned natural language generator and quantitatively analyzing the multi-modal conditioned natural language generator based on the scored performance.

15. The system of claim 10, wherein the server generates the product description by embedding tokens for the clustered and filtered dataset, determining positional encoding for each of the embedded tokens, and combining the embedded tokens and the positional encoding for each of the tokens to generate the multi-modal conditionality.

16. The system of claim 15, wherein the transformer decodes the multi-modal conditionality to the product description into a predetermined natural language.

17. The system of claim 16, wherein the server determines a language modeling loss to determine whether there is a loss between the generated product description and the product description in the predetermined natural language.

18. The system of claim 10, wherein the server transmits one or more natural language words for the product description to a user interface based on at least one input received by the user interface.
